(19) United States
(12) Patent Application Publication
(10) Pub. No.: US 2005/0035100 A1
(43) Pub. Date: Feb. 17, 2005

(54) Method of dividing a plate-like workpiece

(76) Inventor: Satoshi Genda, Tokyo (JP)

Correspondence Address: SMITH, GAMBRELL & RUSSELL, LLP, 1850 M STREET, N.W., SUITE 800, WASHINGTON, DC, 20036, US

(21) Appl. No.: 10/914,154

(22) Filed: Aug. 10, 2004

(30) Foreign Application Priority Data
Aug. 12, 2003 (JP) 2003-292189

(51) Int. Cl. B23K 26/38

(52) U.S. Cl. 219/121.72

(57) ABSTRACT

A method of dividing a plate-like workpiece having a layer that is made of a different material from that of a substrate and is formed on the front surface of the substrate along predetermined dividing lines, comprising a laser beam application step for applying a laser beam along the dividing lines formed on the plate-like workpiece to form a plurality of grooves deeper than the layer and a cutting step for cutting the plate-like workpiece with a cutting blade along the plurality of grooves formed in the laser beam application step, wherein a length between the outer sides of grooves on both sides formed in the laser beam application step is set to be larger than the thickness of the cutting blade and the cutting blade cuts the area between the outer sides of the grooves on both sides in the cutting step.

### FIELD OF THE INVENTION

The present invention relates to a method of dividing a plate-like workpiece such as a semiconductor wafer or the like. More specifically, it relates to a method of dividing a plate-like workpiece having a layer that is made of a different material from that of a substrate and is formed on the front surface of the substrate, along predetermined dividing lines.

### DESCRIPTION OF THE PRIOR ART

As is known to people of ordinary skill in the art, in the production process of semiconductor devices, individual semiconductor chips are manufactured by forming a circuit such as IC or LSI in a plurality of areas sectioned by dividing lines called “streets” formed in a lattice pattern on the front surface of a substantially disk-like semiconductor wafer and cutting the semiconductor wafer along the dividing lines to divide it into the circuit-formed areas. Cutting along the dividing lines of the semiconductor wafer is generally carried out by a cutting machine called “dicer”. This cutting machine comprises a chuck table for holding a semiconductor wafer as a workpiece, a cutting means for cutting the semiconductor wafer held on the chuck table, and a moving means for moving the chuck table and the cutting means relative to each other. The cutting means comprises a rotary spindle that is caused to rotate at a high speed and a cutting blade mounted to the spindle. The cutting blade comprises a disk-like base and an annular edge which is mounted to the outer peripheral portion of a side wall of the base and formed as thick as about 20 to 40 μm by fixing diamond abrasive grains having a diameter of about 3 μm onto the base by electroforming.

To improve the throughput of a circuit such as IC or LSI, a semiconductor wafer having a low-dielectric insulating film (Low-k film) composed of a film of an inorganic material such as SiOF or BSG (SiOB) or a film of an organic material such as a polymer exemplified by polyimide or parylene laminated on the front surface of a semiconductor substrate such as a silicon wafer has recently been implemented. Further, a semiconductor wafer having a metal pattern called “test element group (Teg)” which is formed on dividing lines to check circuits before the semiconductor wafer is divided into individual semiconductor chips has also been implemented.

As the Low-k film consists of multi-layers (5 to 15 layers) like mica and is extremely fragile, when the semiconductor wafer having the above Low-k film laminated thereon is cut along a dividing line with a cutting blade, a problem occurs that the Low-k film falls off, and this falling-off reaches a circuit and causes a fatal damage to a semiconductor chip. When the semiconductor wafer having a metal pattern called “Teg” is cut along a dividing line with a cutting blade, a problem occurs that a burr is formed because the metal pattern is made of a sticky metal such as copper.

To solve the above problems, a dividing method for applying a laser beam along the dividing lines of a semiconductor wafer to remove the Low-k film or Teg and then, positioning a cutting blade to the area from which the Low-k film or Teg has been removed to cut the semiconductor wafer is undertaken. In this connection, a processing machine for carrying out the above dividing method is disclosed in JP-A 2003-320466.

In the above dividing method, a laser beam is applied along a dividing line formed onto a semiconductor wafer to form grooves deeper than the layer of the Low-k film, thereby dividing off or removing the Low-k film. Since the grooves have a small width, a problem occurs that the cutting blade comes in contact with the side faces of the grooves and further, the end faces of the divided Low-k film, thereby falling off the Low-k film and damaging the circuit.

### SUMMARY OF THE INVENTION

It is an object of the present invention to provide a method of dividing a plate-like workpiece having a layer that is made of a different material from that of a substrate and is formed on the front surface of the substrate, comprising applying a laser beam to the plate-like workpiece along predetermined dividing lines to form grooves deeper than the layer and then, cutting the plate-like workpiece along the dividing lines with a cutting blade, wherein the cutting blade can cut the plate-like workpiece without coming into contact with the above layer divided by the grooves.

To attain the above object, according to the present invention, there is provided a method of dividing a plate-like workpiece having a layer that is made of a different material from that of a substrate and is formed on the front surface of the substrate along predetermined dividing lines, comprising a laser beam application step for applying a laser beam along the dividing lines formed on the plate-like workpiece to form a plurality of grooves deeper than the layer and a cutting step for cutting the plate-like workpiece with a cutting blade along the plurality of grooves formed in the laser beam application step, wherein
a length between the outer sides of grooves on both sides formed in the laser beam application step is set to be larger than the thickness of the cutting blade and the cutting blade cuts the area between the outer sides of the grooves on both sides in the cutting step.

Two grooves are formed along the dividing lines in the above laser beam application step and the area between the two grooves is cut in the above cutting step. The layer between the grooves on both sides is removed by forming the plurality of grooves in the above laser beam application step. Further, the above cutting step comprises a first cutting substep for forming a groove having a predetermined depth with a first cutting blade having a predetermined thickness and a second cutting substep for cutting the bottom of the groove formed in the first cutting substep with a second cutting blade having a thickness smaller than the thickness of the first cutting blade.

According to the present invention, since the length between the outer sides of grooves on both sides formed in the laser beam application step is set to be larger than the thickness of the cutting blade, and the cutting blade cuts the area between the outer sides of the grooves on both sides in the cutting step, the cutting blade can cut the plate-like workpiece with high accuracy without coming into contact with the above layer divided by the grooves.

### BRIEF DESCRIPTION OF THE DRAWINGS

FIG. 1 is a perspective view of a semiconductor wafer as a plate-like workpiece to be divided by the present invention, which is supported on a frame by a protective tape;

FIG. 2 is a sectional enlarged view of the semiconductor wafer shown in FIG. 1;

FIGS. 3(a) and 3(b) are explanatory diagrams showing the laser beam application step in the method of dividing a plate-like workpiece according to a first embodiment of the present invention;

FIG. 4 is an enlarged sectional view of a state of the plate-like workpiece which has been subjected to the laser beam application step in the method of dividing a plate-like workpiece according to the first embodiment of the present invention;

FIGS. 5(a) and 5(b) are explanatory diagrams showing the cutting step in the method of dividing a plate-like workpiece according to the first embodiment of the present invention;

FIGS. 6(a) and 6(b) are enlarged sectional views of states of the plate-like workpiece which has been subjected to the cutting step in the method of dividing a plate-like workpiece according to the first embodiment of the present invention;

FIGS. 7(a) and 7(b) are explanatory diagrams showing the first cutting substep of the cutting step in the method of dividing a plate-like workpiece according to a second embodiment of the present invention;

FIGS. 8(a) and 8(b) are explanatory diagrams showing the second cutting substep of the cutting step in the method of dividing a plate-like workpiece according to the second embodiment of the present invention;

FIGS. 9(a), 9(b) and 9(c) are explanatory diagrams showing the method of dividing a plate-like workpiece according to a third embodiment of the present invention; and

FIGS. 10(a), 10(b), 10(c), 10(d) and 10(e) are explanatory diagrams showing the method of dividing a plate-like workpiece according to a fourth embodiment of the present invention.

### DETAILED DESCRIPTION OF THE PREFERRED EMBODIMENTS

The method of dividing a plate-like workpiece according to the present invention will be described in more detail hereinbelow with reference to the accompanying drawings.

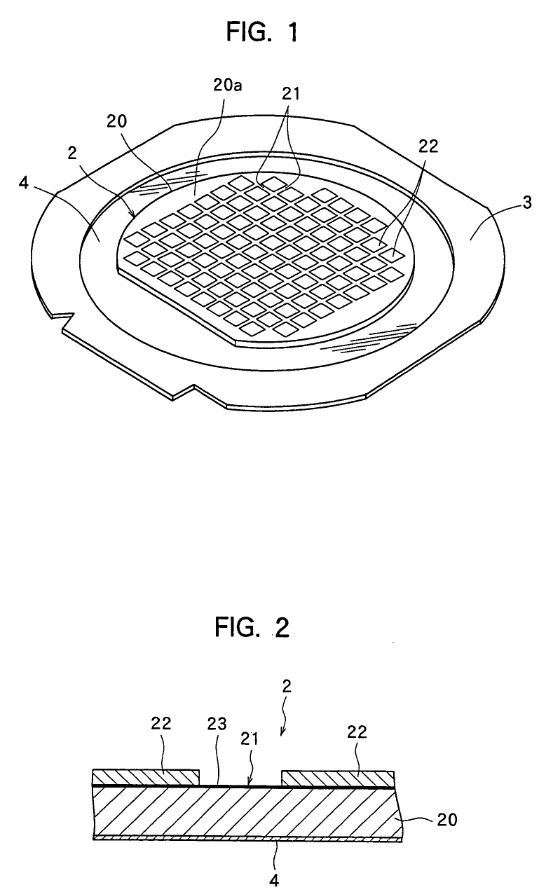

FIG. 1 is a perspective view of a semiconductor wafer as a plate-like workpiece to be divided according to the present invention. In the semiconductor wafer 2 shown in FIG. 1, a plurality of dividing lines 21 are formed in a lattice pattern on the front surface 20a of a substrate 20 which is a silicon wafer, and a circuit 22 is formed in each of a plurality of areas sectioned by the plurality of dividing lines 21. In the illustrated embodiment, as shown in FIG. 2, a low-dielectric insulating film (Low-k film) 23 composed of a film of an inorganic material such as SiOF or BSG (SiOB) or a film of an organic material such as a polymer exemplified by polyimide or parylene is laminated on the front surface 20a of the substrate 20, and the circuits 22 are formed on the front surface of the Low-k film 23. The back surface of the semiconductor wafer 2 thus formed is put to a protective tape 4 affixed to an annular frame 3 as shown in FIG. 1 so that when it is divided into individual semiconductor chips, the semiconductor chips do not fall apart.

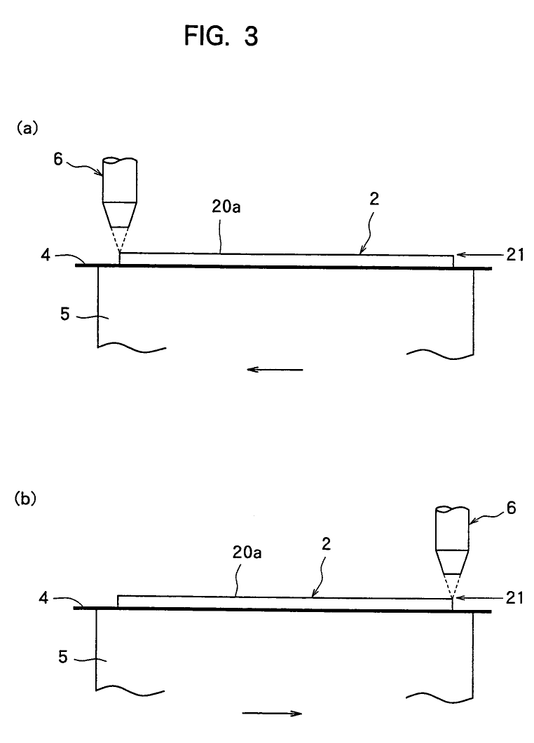

The method of manufacturing semiconductor chips by dividing the above semiconductor wafer 2 into individual semiconductor chips according to a first embodiment of the present invention will be described with reference to FIGS. 3 to 6.

In the method of dividing a plate-like workpiece according to the present invention, the laser beam application step for applying a laser beam along the dividing lines 21 formed on the semiconductor wafer 2 to form grooves deeper than the layer of the Low-k film 23 in the dividing lines 21 is first carried out. That is, as shown in FIGS. 3(a) and 3(b), the semiconductor wafer 2 is placed on the chuck table 5 of a laser beam processing machine in such a manner that its front surface 20a faces up and held on the chuck table 5 by a suction means that is not shown. Thereafter, the chuck table 5 holding the semiconductor wafer 2 is moved to a laser beam processing start position of a laser beam processing area. At this moment, as shown in FIG. 3(a), the semiconductor wafer 2 is positioned such that the application position of laser beam application means 6 is located at one end (left end in FIGS. 3(a)) of a dividing line 21.

After the chuck table 5, that is, the semiconductor wafer 2 is positioned to the laser beam processing start position of the laser beam processing area, the chuck table 5, that is, the semiconductor wafer 2 is moved in a direction indicated by an arrow in FIG. 3(a) at a predetermined feed rate while a pulse laser beam is applied from the laser beam application means 6. When the application position of the laser beam application means 6 reaches the other end of the dividing line 21 as shown in FIG. 3(b), the application of the pulse laser beam is stopped and the movement of the chuck table 5, that is, the semiconductor wafer 2 is also stopped.

Then, the chuck table 5, that is, the semiconductor wafer 2 is moved about 40 μm in a direction perpendicular to the sheet (index-feeding direction). The chuck table 5, that is, the semiconductor wafer 2 is moved in a direction indicated by an arrow in FIG. 3(b) at a predetermined feed rate while a pulse laser beam is applied from the laser beam application means 6. When the application position of the laser beam application means 6 reaches the position shown in FIG. 3(a), the application of the pulse laser beam is stopped and the movement of the chuck table 5, that is, the semiconductor wafer 2 is also stopped.

The laser beam application step is carried out under the following processing conditions.

Light Source: YVO4 Laser or YAG Laser

Wavelength: 355 nm
Output: 4 to 10 W
Repetition frequency: 10 to 100 kHz
Pulse width: 10 to 50 ns
Focusing spot diameter: 10 to 50 μm
Processing feed rate: 100 to 300 mm/sec.

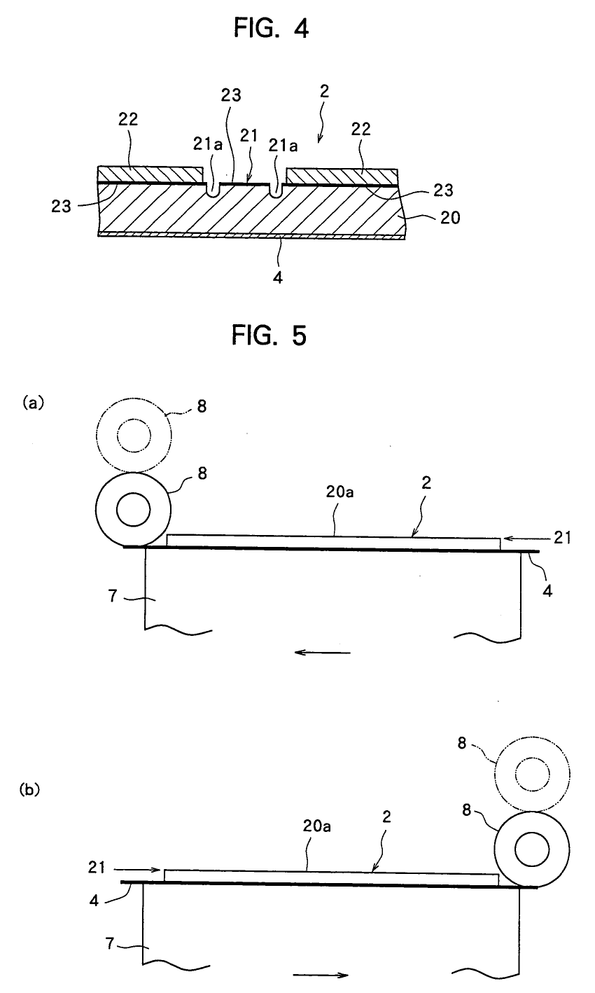

By carrying out the above laser beam application step, two grooves 21a and 21a deeper than the layer of the Low-k film 23 are formed in the dividing line 21 of the semiconductor wafer 2 as shown in FIG. 4. As a result, the Low-k film 23 is divided off by the two grooves 21a and 21a. The length between the outer sides of the two grooves 21a and 21a formed in the dividing line 21 is set to be larger than the thickness of the cutting blade that will be described later. The above laser beam application step is carried out on all the dividing lines 21 formed on the semiconductor wafer 2.

After the above laser beam application step is carried out on all the dividing lines 21 formed on the semiconductor wafer 2, the cutting step for cutting along the dividing lines 21 is carried out. That is, as shown in FIGS. 5(a) and 5(b), the semiconductor wafer 2 which has been subjected to the laser beam application step is placed on the chuck table 7 of a cutting machine in such a manner that its front surface 20a faces up and held on the chuck table 7 by a suction means that is not shown. Thereafter, the chuck table 7 holding the semiconductor wafer 2 is moved to the cutting start position of a cutting area. At this moment, as shown in FIG. 5(a), the semiconductor wafer 2 is positioned such that one end (left end in FIGS. 5(a) and 5(b)) of the dividing line 21 to be cut is situated on the right side by a predetermined amount from a position right below the cutting blade 8. The semiconductor wafer 2 is also positioned such that the cutting blade 8 is situated between the two grooves 21a and 21a formed in the dividing line 21.

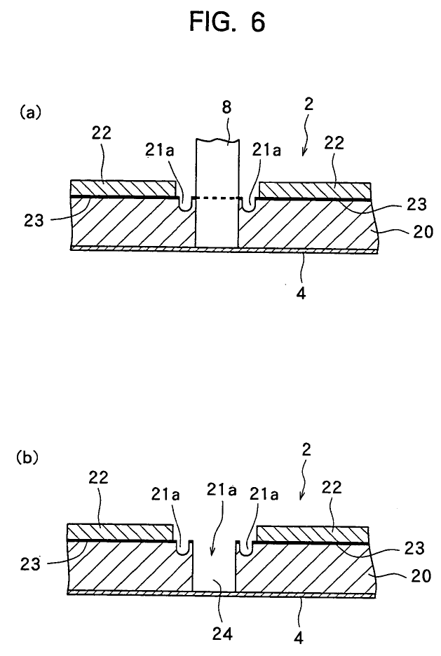

After the chuck table 7, that is, the semiconductor wafer 2 is thus positioned to the cutting start position of the cutting area, the cutting blade 8 is moved down from a standby position shown by a two-dot chain line in FIG. 5(a) to be positioned to a predetermined cut-feeding position shown by a solid line in FIG. 5(a). This cut-feeding position is set to a position where the lower end of the cutting blade 8 reaches the protective tape 4 affixed to the back surface of the semiconductor wafer 2, as shown in FIG. 6(a).

Then, the cutting blade 8 is rotated at a predetermined revolution, and the chuck table 7, that is, the semiconductor wafer 2 is moved in a direction indicated by an arrow in FIG. 5(a) at a predetermined cut-feeding rate. When the chuck table 7, that is, the semiconductor wafer 2 is moved until the other end (right end in FIGS. 5(a) and 5(b)) of the dividing line 21 reaches a position on the left side by a predetermined amount from a position right below the cutting blade 8 as shown in FIG. 5(b), the movement of the chuck table 7, that is, the semiconductor wafer 2 is stopped. By thus moving the chuck table 7, that is, the semiconductor wafer 2, as shown in FIG. 6(b), a groove 24 reaching the back surface is formed between the two grooves 21a and 21a formed in the dividing line 21, thereby cutting the semiconductor wafer 2. When the space between the two grooves 21a and 21a is cut with the cutting blade 8, the Low-k film 23 remaining between the two grooves 21a and 21a is cut with the cutting blade 8 but does not affect the circuit 22 even when it falls off because the film is divided off by the two grooves 21a and 21a at both sides.

The above cutting step is carried out under the following processing conditions.
Cutting blade: outer diameter of 52 mm and thickness of 20 μm
Revolution of cutting blade: 40,000 rpm
Cut-feeding rate: 50 mm/sec

Then, the cutting blade 8 is positioned to the stand-by position shown by the two-dot chain line in FIG. 5(b), and the chuck table 7, that is, the semiconductor wafer 2 is moved in the direction shown by the arrow in FIG. 5(b) and returned to the position shown in FIG. 5(a). Thereafter, the chuck table 7, that is, the semiconductor wafer 2 is index-fed by a predetermined amount corresponding to the interval between the dividing lines 21 in a direction perpendicular to the sheet (index-feeding direction) and then, the dividing line 21 to be cut next is aligned with the cutting blade 8. After the dividing line 21 to be cut next is aligned with the cutting blade 8, the above cutting step is carried out.

The above cutting step is carried out on all the dividing lines 21 formed on the semiconductor wafer 2. As a result, the semiconductor wafer 2 is cut along the dividing lines 21 to be divided into individual semiconductor chips.

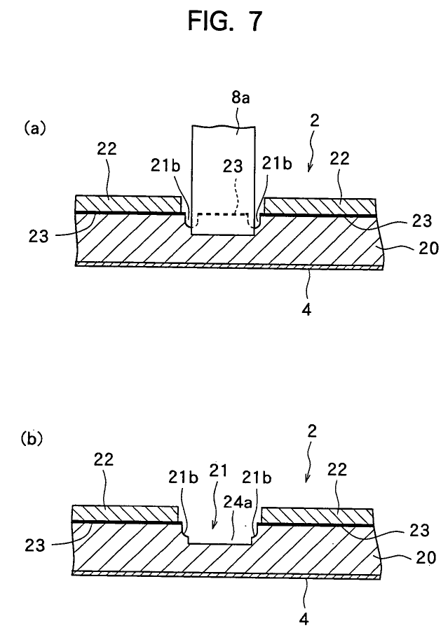

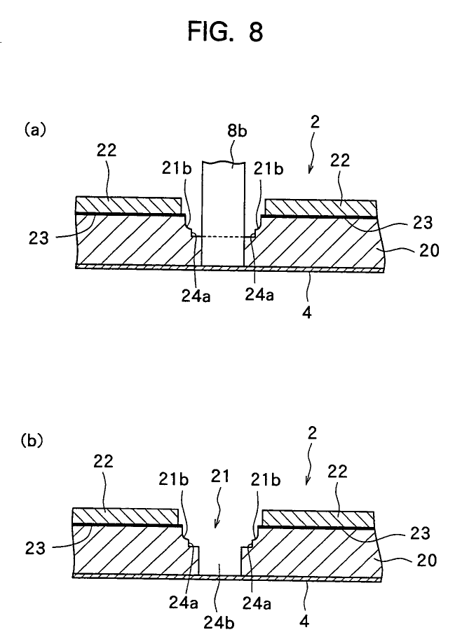

A description is subsequently given of the method of dividing a plate-like workpiece according to a second embodiment of the present invention with reference to FIGS. 7(a) and 7(b) and FIGS. 8(a) and 8(b).

In the second embodiment, the laser beam application step is the same as that of the first embodiment and the cutting step differs from that of the first embodiment. That is, in the second embodiment, the cutting step is divided into a first cutting substep and a second cutting substep.

In the first cutting substep, the semiconductor wafer 2 having two grooves 21b and 21b that have been formed deeper than the layer of the Low-k film 23 in all the dividing lines 21 in the laser beam application step as shown in FIG. 4 is placed and held on the chuck table 7 in such a manner that its front surface 20a faces up as shown in FIG. 5(a), like the above first embodiment. Then, as shown in FIG. 5(a), the chuck table 7 holding the semiconductor wafer 2 is moved to the cutting start position of the cutting area like the above first embodiment. The semiconductor wafer 2 is positioned such that the cutting blade is situated between the outer sides of the two grooves 21b and 21b formed in the dividing line 21, like the first embodiment. In the first cutting substep, a first cutting blade 8a having a predetermined thickness (for example, 40 μm) is used. Therefore, as shown in FIG. 7(a), the first cutting blade 8a is situated between the centers of the two grooves 21b and 21b. The cut-feeding position of the first cutting blade 8a is set to a position deeper than the two grooves 21b and 21b, for example, a position 20 μm from the front surface of the semiconductor wafer 2. Other processing conditions are made the same as those of the cutting step in the above first embodiment to carry out the cutting work. As a result, as shown in FIG. 7(b), a groove 24a having a depth of 20 μm is formed between the outer sides of the two grooves 21b and 21b in the dividing line 21 of the semiconductor wafer 2. In the first cutting substep, the Low-k film 23 remaining between the two grooves 21b and 21b is cut with the cutting blade 8 but does not affect the circuit 22 even when it falls off because the film is divided by the two grooves 21b and 21b at both sides.

After the above first cutting substep is carried out on all the dividing lines 21 formed on the semiconductor wafer 2, the second cutting substep for cutting the bottom of the groove 24a which has been formed in the dividing lines of the semiconductor wafer 2 in the first cutting substep is carried out.

In the second cutting substep, a second cutting blade 8b having a thickness (for example, 20 μm) smaller than the thickness of the first cutting blade 8a, as shown in FIG. 8(a) is used. That is, as shown in FIG. 8(a), the second cutting blade 8b is positioned at the center in the width direction of the groove 24a which has been formed in the dividing line 21 of the semiconductor wafer 2 in the first cutting substep and the lower end of the second cutting blade 8b is positioned to a cut-feeding position where it reaches the protective tape 4 affixed to the back surface of the semiconductor wafer 2. Other processing conditions are made the same as those of the cutting step in the first embodiment to carry out the cutting work. As a result, as shown in FIG. 8(b), a groove 24b reaching the back surface is formed in the bottom of the groove 24a formed in the dividing line 21, thereby cutting the semiconductor wafer 2. The semiconductor wafer 2 is divided into individual semiconductor chips along the dividing lines 21 by carrying out this second cutting substep on the bottoms of all the grooves 24a formed in the first cutting substep.

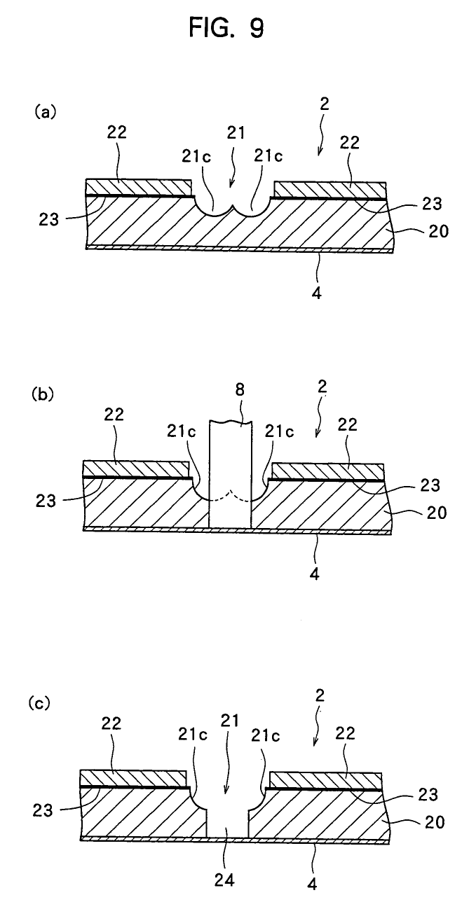

A description is subsequently given of the method of dividing a plate-like workpiece according to a third embodiment of the present invention with reference to FIGS. 9(a) to 9(c).

In the third embodiment, as shown in FIG. 9(a), two grooves 21c and 21c are formed in the dividing lines 21 of the semiconductor wafer 2 in the laser beam application step in such a manner that their inner sides overlap with each other to remove the Low-k film 23 in the cutting area with a cutting blade later described. The width of the cutting area from which the Low-k film 23 has been removed is set to be larger than the thickness of the cutting blade.

After the laser beam application step is carried out as described above, the same cutting step as in the first embodiment is carried out. That is, as shown in FIG. 9(b), the cutting blade 8 having a thickness of 20 μm, for example, is positioned at the center in the width direction of the grooves 21c and 21c and the lower end of the cutting blade 8 is positioned to a cut-feeding position where it reaches the protective tape 4 affixed to the back surface of the semiconductor wafer 2. Other processing conditions are made the same as those of the cutting step in the first embodiment to carry out the cutting work. As a result, as shown in FIG. 9(c), a groove 24 reaching the back surface is formed along the two grooves 21c and 21c formed in the dividing line 21, thereby cutting the semiconductor wafer 2. Since in the third embodiment, the Low-k film 23 in the cutting area is removed in the laser beam application step with the cutting blade, the falling-off of the Low-k film in the cutting step can be eliminated.

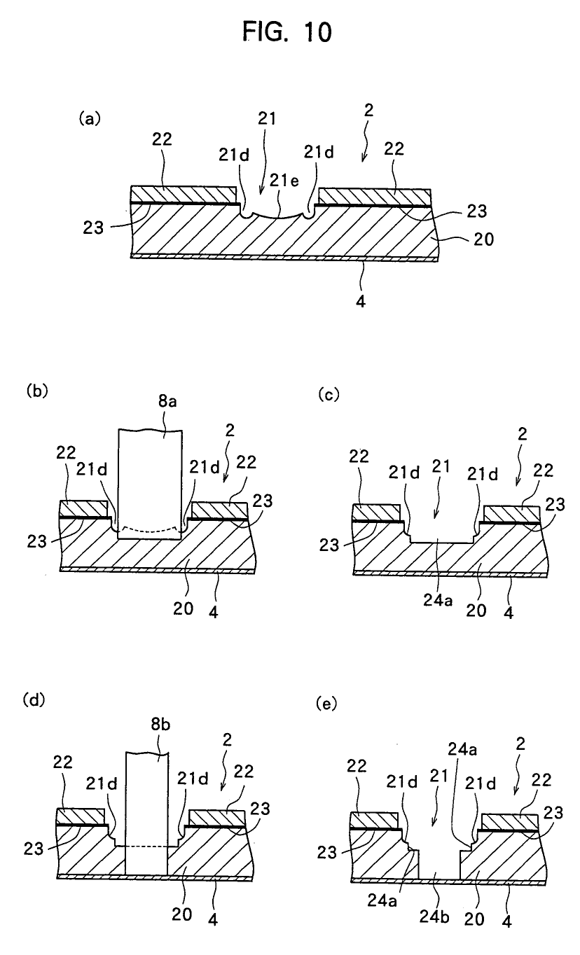

A description is subsequently given of the method of dividing a plate-like workpiece according to a fourth embodiment of the present invention with reference to FIGS. 10(a) to 10(e).

In the fourth embodiment, as shown in FIG. 10(a), three grooves 21d, 21e and 21d are formed in the dividing lines 21 of the semiconductor wafer 2 in the laser beam application step in such manner that adjacent grooves overlap with each other, whereby the Low-k film 23 in the cutting area is remove with the cutting blade later described. To form the three grooves 21d, 21e and 21d, it is desired that right and left grooves 21d and 21d should be first formed and then, the central groove 21e should be formed so that the sectional form of the obtained groove as the whole becomes bisymmetrical. In the illustrated embodiment, the central groove 21e is wider than the grooves 21d and 21d. To form the central groove 21e, the application conditions of a laser beam are changed from those for forming the grooves 21d and 21d.

After the laser beam application step is carried out as described above, the cutting step is carried out by dividing into two steps, i.e., a first cutting substep and a second cutting substep like the second embodiment. That is, the first cutting blade 8a having a thickness of 40 μm, for example, is used in the first cutting substep, and it is positioned at the center in the width direction of the above grooves 21d, 21e and 21d and is cut-fed to a depth of 20 μm from the surface of the semiconductor wafer 2. Other processing conditions are made the same as those of the cutting step in the first embodiment to carry out the cutting work. As a result, as shown in FIG. 10(c), a groove 24a having a depth of 20 μm is formed between the outer sides of the grooves 21d and 21d in the dividing line 21 of the semiconductor wafer 2. In this first cutting substep, as the Low-k film 23 in the cutting area is removed with the cutting blade in the laser beam application step, the falling-off of the Low-k film in the first cutting substep can be eliminated. By forming the grooves 21d, 21e and 21d as the whole bisymmetrically, the damage (curving) of the first cutting blade 8a in the first cutting substep is reduced.

After the groove 24a is formed in the dividing lines 21 of the semiconductor wafer 2 in the above first cutting substep, the second cutting substep for cutting the bottom of the groove 24a is carried out. That is, as shown in FIG. 10(d), the second cutting blade 8b having a thickness of 20 μm, for example, is used, and it is positioned at substantially the center in the width direction of the groove 24a and the lower end of the second cutting blade 8b is positioned to a cut-feeding position where it reaches the protective tape 4 affixed to the back surface of the semiconductor wafer 2. Other processing conditions are made the same as those of the cutting step in the first embodiment to carry out the cutting work. As a result, as shown in FIG. 10(e), a groove 24b reaching the back surface is formed in the bottom of the groove 24a formed in the dividing lines 21, thereby cutting the semiconductor wafer 2. In the second cutting substep, as the area roughened by the laser beam application step is removed in the first cutting substep using the first cutting blade 8a which is relatively thick, the cutting with the thin second cutting blade 8b is carried out smoothly and chippings are hardly produced on the back surface of the semiconductor wafer 2.

1. A method of dividing a plate-like workpiece having a layer that is made of a different material from that of a substrate and is formed on the front surface of the substrate along predetermined dividing lines, comprising a laser beam application step for applying a laser beam along the dividing lines formed on the plate-like workpiece to form a plurality of grooves deeper than the layer and a cutting step for cutting the plate-like workpiece with a cutting blade along the plurality of grooves formed in the laser beam application step, wherein
a length between the outer sides of grooves on both sides formed in the laser beam application step is set to be larger than the thickness of the cutting blade and the cutting blade cuts the area between the outer sides of the grooves on both sides in the cutting step.

2. The method of dividing a plate-like workpiece according to claim 1, wherein two grooves are formed along the dividing lines in the laser beam application step and the area between the two grooves is cut in the cutting step.

3. The method of dividing a plate-like workpiece according to claim 1, wherein the layer between the grooves on both sides is removed by forming the plurality of grooves in the laser beam application step.

4. The method of dividing a plate-like workpiece according to claim 1, wherein the cutting step comprises a first cutting substep for forming a groove having a predetermined depth with a first cutting blade having a predetermined thickness and a second cutting substep for cutting the bottom of the groove formed in the first cutting substep with a second cutting blade having a thickness smaller than the thickness of the first cutting blade.
